(19) United States
(12) Patent Application Publication
(10) Pub. No.: US 2023/0258534 A1
(43) Pub. Date: Aug. 17, 2023

(54) TIRE OBSERVATION APPARATUS

(71) Applicant: Murata Manufacturing Co., Ltd., Nagaokakyo-shi (JP)

(72) Inventor: Seiji INNAMI, Nagaokakyo-shi (JP)

(21) Appl. No.: 18/138,209

(22) Filed: Apr. 24, 2023

Related U.S. Application Data
(63) Continuation of application No. PCT/JP2021/040979, filed on Nov. 8, 2021.

(30) Foreign Application Priority Data
Nov. 10, 2020 (JP) 2020-186957

(51) Int. Cl. G01M 17/02

(52) U.S. Cl. CPC G01M 17/02

(57) ABSTRACT

A tire observation apparatus includes an imager to acquire image information on a traveling vehicle, a trajectory estimator, a position adjuster, and a movable assembly. The trajectory estimator is operable to estimate a trajectory of a tire based on image information obtained at at least one point in time and tire information including at least one of a width, a diameter, and a groove pattern of the tire. The position adjuster calculates, based on the trajectory, an adjustment amount that satisfies observation conditions regarding a position and an angle of the imager to observe a state of the tire. The movable assembly changes the position and the angle of the imager based on the adjustment amount.

### CROSS REFERENCE TO RELATED APPLICATIONS

This application claims the benefit of priority to Japanese Patent Application No. 2020-186957 filed on Nov. 10, 2020 and is a Continuation Application of PCT Application No. PCT/JP2021/040979 filed on Nov. 8, 2021. The entire contents of each application are hereby incorporated herein by reference.

### BACKGROUND OF THE INVENTION

### 1. Field of the Invention

The present invention relates to an apparatus that captures an image of a tire of a traveling vehicle and observes the tire.

### 2. Description of the Related Art

The number of tire troubles has been increasing every year. Decreases in interest in tires and decreases in the frequency of checks due to decreased fuel consumption of vehicles are major causes of tire troubles, and the number of tire troubles seem to continue to increase.

Existing tire observation methods include a check during vehicle travel, a daily check, and a legal check. For example, a tire pressure monitoring system (TPMS) is used for a check during vehicle travel. A daily check and a legal check are conducted by visual inspection of tire surfaces.

Attention should be paid to the frequency of how often daily checks are made. Because most defects in tires, such as air pressure, remaining grooves, uneven wear, and cracks, can be detected only by a surface inspection, a decrease in the frequency of daily checks is expected to result in a fatal problem.

In order to automatically observe the state of the surface of a tire, systems capable of observing and inspecting the state of a tire during real vehicle travel without requiring removal of the tire are disclosed in Japanese Unexamined Patent Application Publication No. 2017-500540 and Japanese Unexamined Patent Application Publication No. 2017-198672.

### SUMMARY OF THE INVENTION

However, in the apparatuses disclosed in Japanese Unexamined Patent Application Publication No. 2017-500540 and Japanese Unexamined Patent Application Publication No. 2017-198672, it is not easy to adjust, at the time of observation of a tire, the position and the angle of an imaging device with respect to the tire to a position and an angle that are more suitable for observation, and it is difficult to observe the tire with high measurement accuracy.

Preferred embodiments of the present invention adjust, at a time of observation of a tire, a position and an angle of an imaging device with respect to the tire to a position and an angle that are more suitable for observation.

A tire observation apparatus as an example of a preferred embodiment of the present disclosure includes an imager, a trajectory estimator, a position adjuster, and a movable assembly. The imager is operable to acquire image information on a traveling vehicle including a tire. The trajectory estimator is operable to estimate a trajectory of the tire based on image information obtained at at least one point in time and tire information including at least one of a width of the tire, a diameter of the tire, and a groove pattern of the tire. The position adjuster is operable to calculate, based on the trajectory, an adjustment amount that satisfies observation conditions regarding a position and an angle of the imaging device for observation of a state of the tire. The movable assembly changes the position and the angle of the imaging device based on the adjustment amount.

With this arrangement, since the trajectory of the tire is estimated based on the tire information based on features such as a shape of the tire and first image information indicating a captured image of the tire, the accuracy in estimation of the trajectory of the tire increases. In addition, since the position and the angle of the imaging device are adjusted based on a result of the estimation of the trajectory of the tire, the accuracy in adjustment of the position and the angle of the imaging device with respect to the tire increases.

According to preferred embodiments of the present invention, the position and the angle of an imaging device with respect to a tire at the time of observation of the tire can be adjusted to a position and an angle that are more suitable for observation.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a conceptual diagram illustrating the overall configuration of a tire observation apparatus 101 according to a preferred embodiment of the present invention.

FIG. 2 is a block diagram illustrating a configuration of the tire observation apparatus 101.

FIGS. 3A to 3D are diagrams illustrating examples of the shape of a tire in a captured image frame.

FIGS. 4A and 4B are diagrams illustrating an estimated angle of an observation target tire with respect to an imaging device 11.

FIG. 5 is a plan view illustrating an example of a change of the position of a tire with time.

FIGS. 6A to 6C are diagrams illustrating relationships regarding the position and the angle between the imaging device 11 and a tire 20.

FIG. 7 includes a side view, plan views, and diagrams illustrating captured images in front-wheel search.

FIG. 8 includes side views, plan views, and diagrams illustrating captured images in front-wheel measurement.

FIG. 9 includes a side view, plan views, and diagrams illustrating captured images in rear-wheel search.

FIG. 10 includes side views, plan views, and diagrams illustrating captured images in rear-wheel measurement.

FIG. 11 is a block diagram illustrating a configuration of a tire observation system including the tire observation apparatus 101.

FIG. 12 is a diagram illustrating an example of a tire observation management table.

FIG. 13 is a flowchart illustrating an example of the procedure for a process of an observation target vehicle, the tire observation apparatus 101, and an information processing apparatus 102.

FIG. 14 is a flowchart, continuing from FIG. 13, illustrating the example of the procedure for the process of the observation target vehicle, the tire observation apparatus 101, and the information processing apparatus 102.

FIG. 15 is a flowchart illustrating the details of processing of step S12 in FIG. 14.

FIG. 16 is a flowchart illustrating the details of processing of step S11 in FIG. 14.

### DETAILED DESCRIPTION OF THE PREFERRED EMBODIMENTS

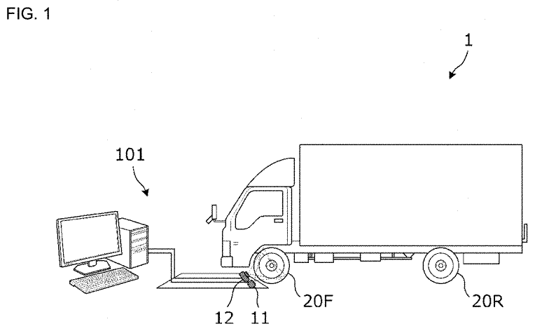

FIG. 1 is a conceptual diagram illustrating the overall configuration of a tire observation apparatus 101 according to a preferred embodiment of the present invention. The tire observation apparatus 101 includes an imaging device 11 and a lighting device 12.

The imaging device 11 captures an image including a tire (observation target tire) of a traveling vehicle 1. For example, the imaging device 11 captures an image of a front-wheel tire 20F when the front-wheel tire 20F of the vehicle 1 passes through the position of the imaging device 11, and the imaging device 11 captures an image of a rear-wheel tire 20R when the rear-wheel tire 20R of the vehicle 1 passes through the position of the imaging device 11. The lighting device 12 emits light for imaging to an imaging range of the imaging device 11, that is, an imaging range including an observation target tire.

At this time, by using a method described below, the position and the angle of the imaging device 11 with respect to a tire are adjusted to a position and an angle that are suitable for observation of the tire. In other words, at the time of observation of a tire, the positional relationship between the imaging device 11 and the tire is adjusted to a positional relationship suitable for observation of the tire.

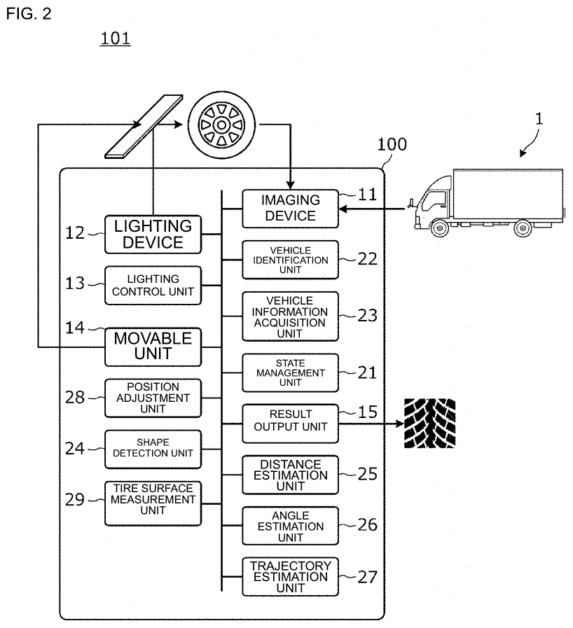

FIG. 2 is a block diagram illustrating a configuration of the tire observation apparatus 101. The tire observation apparatus 101 includes a tire observation section 100. The tire observation section 100 includes the imaging device 11, the lighting device 12, a lighting control unit 13, a movable unit 14, and a result output unit 15.

The imaging device 11 captures an image of an observation target tire. The lighting device 12 illuminates a region to be imaged by the imaging device 11. The lighting control unit 13 controls an illuminating direction of the lighting device 12. The movable unit 14 controls an imaging position and angle so that the imaging device 11 can capture an image of an observation target tire from an appropriate direction (specifically, a front direction with respect to a surface over which the tire travels). The result output unit 15 outputs a result of observation of a tire to the outside.

Furthermore, the tire observation section 100 includes a state management unit 21, a vehicle identification unit 22, a vehicle information acquisition unit 23, a shape detection unit 24, a distance estimation unit 25, an angle estimation unit 26, a trajectory estimation unit 27, and a position adjustment unit 28. The above-mentioned units have functions described below.

### State Management Unit

The state management unit 21 manages transitions between five states: (a) vehicle search, (b) front-wheel search, (c) front-wheel measurement, (d) rear-wheel search, and (e) rear-wheel measurement. In the case where a vehicle includes rear-front wheels and rear-rear wheels as well as front wheels and rear wheels, transitions between the above-mentioned five states are made for each tire. The individual states and transition conditions for the individual states will be described below.

State (1): After a stand-by time until recognition of a measurement target vehicle, when the vehicle is recognized, tire information is acquired. The tire information includes at least one of a tire width, a tire diameter, and a tire groove pattern. A vehicle or a tire is identified based on an image captured by the imaging device 11 or an electronic tag (for example, an RFID tag) arranged at the vehicle or the tire.

When the observation target vehicle is identified and the tire information is acquired from the vehicle information acquisition unit 23 in the state (1), transition to state (2) occurs.

State (2): Position detection, angle detection, and trajectory estimation of a front-wheel tire are performed, and position control and angle control of the imaging device and the lighting device are performed in accordance with the position detection, the angle detection, and the trajectory estimation of the front-wheel tire.

When the distance between the front-wheel tire and the imaging device 11 becomes less than or equal to a threshold value in the state (2), transition to state (3) occurs.

State (3): Surface measurement of the front-wheel tire is performed.

When measurement for a measurement range for the front-wheel tire finishes in the state (3), transition to state (4) occurs.

State (4): Position detection, angle detection, and trajectory estimation of a rear-wheel tire are performed, and position control and angle control of the imaging device and the lighting device are performed in accordance with the position detection, the angle detection, and the trajectory estimation of the rear-wheel tire.

When the distance between the rear-wheel tire and the imaging device becomes less than or equal to a threshold value in the state (4), transition to state (5) occurs.

State (5): Surface measurement of the rear-wheel tire is performed.

When measurement for a measurement range for the rear-wheel tire finishes in the state (5), transition to the state (1) occurs.

### Vehicle Identification Unit

The vehicle identification unit 22 identifies an observation target vehicle. For example, the vehicle identification unit 22 identifies an observation target vehicle by recognizing a number plate in a captured image. Alternatively, for example, the vehicle identification unit 22 identifies an observation target vehicle by reading an RFID tag provided at the vehicle.

### Vehicle Information Acquisition Unit

The vehicle information acquisition unit 23 refers to a result output from the vehicle identification unit 22 and acquires data on tire information (diameter, width, etc.) of an observation target vehicle. That is, the vehicle information acquisition unit 23 functions as a tire information acquisition unit. The vehicle information acquisition unit 23 may acquire data on the type of vehicle (distance between front and rear tires, distance between left and right tires, etc.) as well as the tire information. A database to which a reference is made regarding a vehicle ID and vehicle information is configured in a memory in the tire observation apparatus 101, which will be described later, or on the cloud.

### Shape Detection Unit

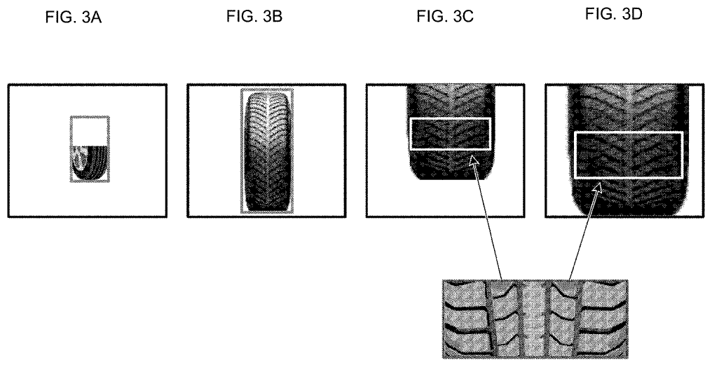

The shape detection unit 24 detects the shape of a tire in a captured image. The shape of a tire includes at least a rectangular outline of the entire tire, and it is desirable that the shape of the tire include the contour of the outer circumference of the tire and the contour of the inner circumference of the tire. FIGS. 3A to 3D are diagrams illustrating examples of the shape of a tire in a captured image frame. In the case where the entire tire is included in a frame as illustrated in FIGS. 3A and 3B, the rectangular outline of the entire tire is detected. In the case where a portion of a tire is included in a frame as illustrated in FIGS. 3C and 3D, processing for detecting a predetermined geometric shape corresponding to a groove pattern of the tire is performed. For example, each of the detection processes described above is performed by pattern matching processing or machine learning. Furthermore, the above-described processes include processing for detecting the position in the vehicle at which the detected tire is installed.

### Distance Estimation Unit

The distance estimation unit 25 refers to the shape of a tire detected by the shape detection unit 24 and tire information (diameter and width) and estimates the distance from the imaging device to the tire. The tire information includes at least the width of a tire.

### Angle Estimation Unit

The angle estimation unit 26 refers to the shape of a tire detected by the shape detection unit 24 and tire information (diameter and width) and estimates the angle of the traveling direction of the tire with respect to the imaging device.

### Trajectory Estimation Unit

The trajectory estimation unit 27 estimates the trajectory of a tire based on a result of detection by the shape detection unit 24 and results of estimation by the distance estimation unit 25 and the angle estimation unit 26. The trajectory of a tire is a path through which the tire approaches the imaging device 11. The trajectory estimation unit 27 estimates the trajectory of a tire based on image information (first image information) captured at a first point in time and the positional relationship between the tire and the imaging device.

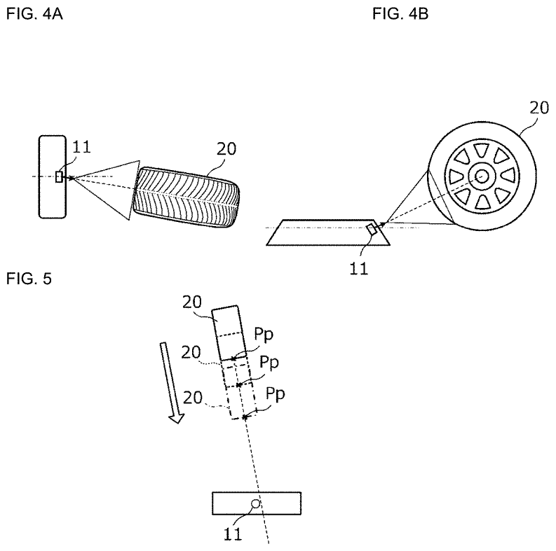

FIGS. 4A and 4B are diagrams illustrating an estimation angle of an observation target tire with respect to the imaging device 11. FIG. 4A is a plan view, and FIG. 4B is a side view of the state illustrated in FIG. 4A. The angle between the direction of an arrow in FIG. 4A and a reference direction (the direction of a dot-and-dash line in FIG. 4A) is the angle in the direction of the horizontal plane (horizontal direction angle) of a tire 20 with respect to the imaging device 11. The reference direction is, for example, a direction orthogonal to a direction in which the imaging device 11 is moved by the movable unit 14. The angle between the direction of an arrow in FIG. 4B and the horizontal plane (plane including a two-dots-and-dash line in FIG. 4B) is the angle in the height direction (vertical direction angle) of the tire 20 with respect to the imaging device 11. Adjustment of the vertical direction angle will be described in detail later.

The trajectory estimation unit 27 estimates the trajectory of a tire using at least one of a plurality of methods described below.

(A) The trajectory estimation unit 27 estimates the trajectory of a tire based on tire information and image information on the tire. The tire information includes at least one of the width of the tire, the diameter of the tire, and the groove pattern of the tire. The tire information is acquired from the vehicle information acquisition unit 23. The tire information may be provided by manual input by an operator.

The trajectory estimation unit 27 estimates the traveling direction of the tire and the position of the tire with respect to the imaging device based on a result of comparison between at least one of the width of the tire, the diameter of the tire, and the groove pattern of the tire and image information on the tire. More specifically, the trajectory estimation unit 27 detects at least one of the width of the tire, the diameter of the tire, and the groove pattern of the tire from the image information on the tire.

The trajectory estimation unit 27 estimates the traveling direction of the tire and the position of the tire with respect to the imaging device by comparing a result of detection from the image with tire information. The trajectory estimation unit 27 performs processing for estimating the traveling direction of the tire and the position of the tire with respect to the imaging device a plurality of times and estimates the trajectory of the tire based on results of the plurality of estimations.

(B) The trajectory estimation unit 27 estimates the trajectory of a tire based on the shape of the tire obtained from image information on the tire.

More specifically, the trajectory estimation unit 27 extracts at least one of the contour of the outer circumference of the tire and the contour of the inner circumference of the tire from the image information on the tire. The trajectory estimation unit 27 estimates the width of the tire or the dimeter of the tire in the image based on the contour of the outer circumference of the tire or the contour of the inner circumference of the tire. The trajectory estimation unit 27 acquires, as tire information, the width of the tire or the diameter of the tire from the vehicle information acquisition unit 23.

The trajectory estimation unit 27 calculates the distance between the tire and the imaging device 11 and the angle (horizontal direction angle) of the tire with respect to the imaging device 11 by comparing the width of the tire or the diameter of the tire estimated from the image with the width of the tire or the diameter of the tire based on the tire information, and estimates the trajectory of the tire.

(C) The trajectory estimation unit 27 estimates the trajectory of a tire based on the contour shape of the entire tire obtained from image information on the tire.

More specifically, the trajectory estimation unit 27 extracts the contour shape of the entire tire from the image information on the tire. The trajectory estimation unit 27 estimates the width of the tire or the diameter of the tire based on an image based on the contour shape of the entire tire. The trajectory estimation unit 27 acquires, as tire information, the width of the tire or the diameter of the tire from the vehicle information acquisition unit 23.

The trajectory estimation unit 27 calculates the distance between the tire and the imaging device 11 and the angle (horizontal direction angle) of the tire with respect to the imaging device 11 by comparing the width of the tire or the diameter of the tire estimated from the image with the width of the tire or the diameter of the tire based on the tire information, and calculates the positional relationship between the imaging device 11 and the tire. The trajectory estimation unit 27 plots positional coordinates of the tire on a coordinate system representing the horizontal plane based on the calculated positional relationship.

FIG. 5 is a plan view illustrating an example of a change of the position of a tire with time. In FIG. 5, Pp represents a plot point, and a dotted line connecting a plurality of plot points Pp represents an estimated trajectory of a tire. The trajectory estimation unit 27 calculates coordinates of positions of the tire at a plurality of points in time and plots the positions of the tire at the plurality of points in time (see plot points Pp in FIG. 5). The trajectory estimation unit 27 estimates the trajectory of a tire (see the dotted line in FIG. 5) based on the plotted positions at the plurality of points in time and the temporal arrangement of the plotted positions at the plurality of points in time.

### Position Adjustment Unit

The position adjustment unit 28 calculates the adjustment amount of the position and the angle of the imaging device 11 based on an estimated trajectory of a tire so that an image in which the shape of the tire is positioned at the front and center can be captured at a second point in time that is after the first point in time. That is, the position adjustment unit 28 calculates the adjustment amount, based on a result of estimation of the trajectory of the tire 20 calculated by the trajectory estimation unit 27, so that, at the time of observation of the tire, the imaging device 11 satisfies observation conditions, in other words, the imaging device 11 is at the position and the angle (horizontal direction angle and vertical direction angle) that are suitable for observation of the tire. Furthermore, different imaging devices 11 may be used for left and right tires, and an adjustment may be made in such a manner that the distance between the imaging device 11 for a left tire and the imaging device 11 for a right tire is equal to the distance between the left and right tires.

For example, at the time of observation of a tire, the position adjustment unit 28 calculates the adjustment amount of position so that the position of the imaging device 11 in the horizontal direction is arranged on the front of the tire 20. At the time of observation of a tire, the position adjustment unit 28 calculates the adjustment amount of the horizontal direction angle so that the imaging device 11 faces the front of the traveling surface of the tire 20.

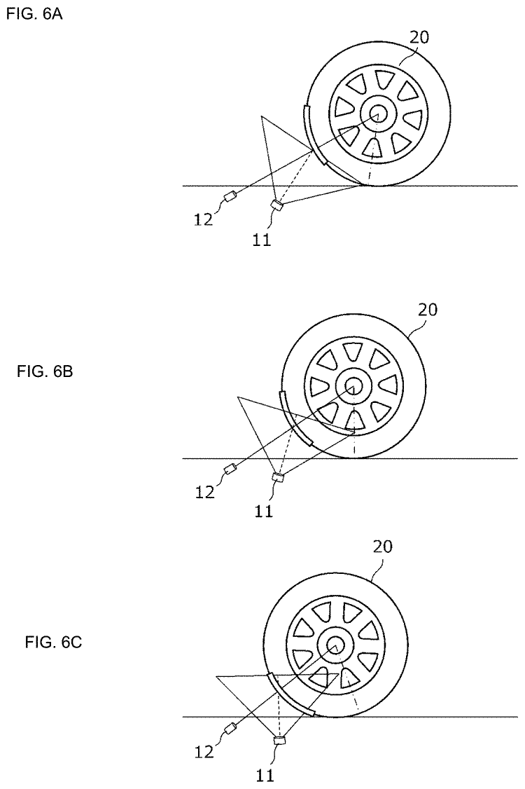

FIGS. 6A to 6C are diagrams illustrating relationships regarding the position and the angle (vertical direction angle) between the imaging device 11 and the tire 20. As illustrated in FIGS. 6A to 6C, the position adjustment unit 28 calculates the adjustment amount of the vertical direction angle of the imaging device 11 so that the center of the irradiation range of the lighting device 12 is set to the center direction of the tire 20 and the intersection between a line connecting the centers of the lighting device 12 and the tire 20 and the surface of the tire 20 is set to the center of imaging.

The above-described adjustment of the vertical direction angle of the imaging device 11 is performed after estimation of the trajectory of the tire is completed and adjustment of the position and the horizontal direction angle of the imaging device 11 is completed. Adjustment of the vertical direction angle of the lighting device 12 is performed in a manner similar to the adjustment of the vertical direction angle of the imaging device 11.

### Movable Unit

The movable unit 14 changes the position and the angle (horizontal direction angle and the vertical direction angle) of the imaging device 11 or the lighting device 12 based on the adjustment amount calculated by the position adjustment unit 28. Thus, at the time of observation of the tire, that is, under observation conditions, the imaging device 11 and the lighting device 12 are arranged at positions and angles that are suitable for observation of the tire (appropriate positions and angles for observation of the tire).

### Tire Surface Measurement Unit

A tire surface measurement unit 29 measures the surface of a tire.

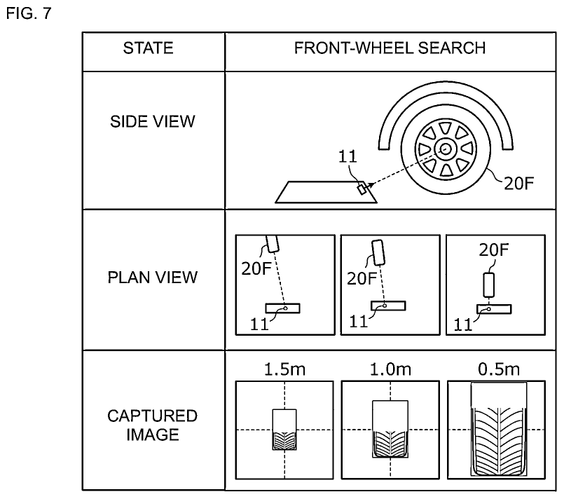

Next, control of the units of the tire observation apparatus 101 will be described. FIG. 7 includes a side view, plan views, and diagrams illustrating captured images in front-wheel search. The horizontal direction angle of the imaging device 11 under observation conditions is controlled so that the shape of the front-wheel tire 20F is positioned at the front and center in a captured image based on the adjustment amount of the horizontal direction angle and the position in the left-right direction of the imaging device 11 is controlled so that the shape of the front-wheel tire 20F in the captured image is positioned at the front and center in the captured image.

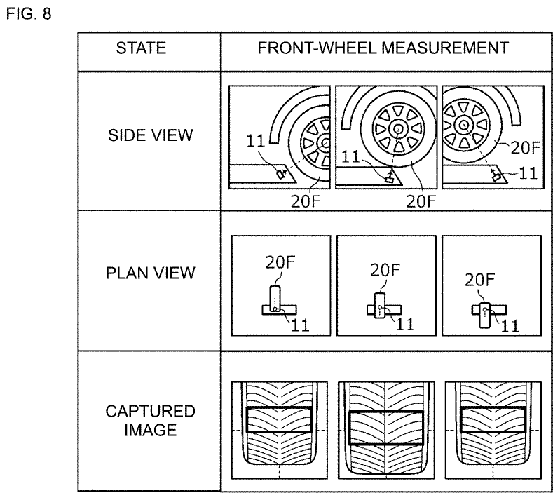

FIG. 8 includes side views, plan views, and diagrams illustrating captured images in front-wheel measurement. The angle on the horizontal plane of the imaging device 11 is the same as the last state of the front-wheel search illustrated in FIG. 7. Thus, the front-wheel tire 20F as an observation target passes over the imaging device 11. When the distance between the front-wheel tire 20F and the imaging device 11 becomes less than a threshold value, the vertical direction angles of the imaging device 11 and the lighting device 12 are controlled to predetermined angles based on the adjustment amounts of the vertical direction angles. In FIG. 8, illustration of the lighting device 12 is omitted.

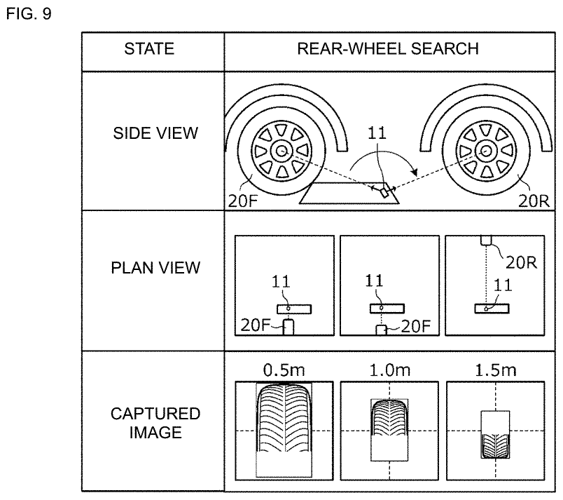

FIG. 9 includes a side view, plan views, and diagrams illustrating captured images in rear-wheel search. When the distance between the front-wheel tire 20F and the imaging device 11 becomes more than the threshold value, search for the rear-wheel tire 20R starts. A search method for the rear-wheel tire 20R is similar to the search method for the front-wheel tire 20F.

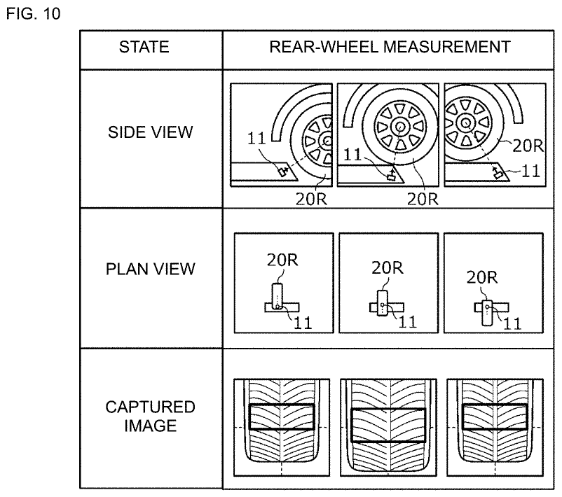

FIG. 10 includes side views, plan views, and diagrams illustrating captured images in rear-wheel measurement. The angle on the horizontal plane of the imaging device 11 is the same as the last state in the rear-wheel search illustrated in FIG. 9. Thus, the rear-wheel tire 20R as an observation target passes over the imaging device 11. When the distance between the rear-wheel tire 20R and the imaging device 11 becomes less than the threshold value, the vertical direction angles of the imaging device 11 and the lighting device 12 are controlled to predetermined angles based on the adjustment amounts of the vertical direction angles. In FIG. 10, illustration of the lighting device 12 is omitted.

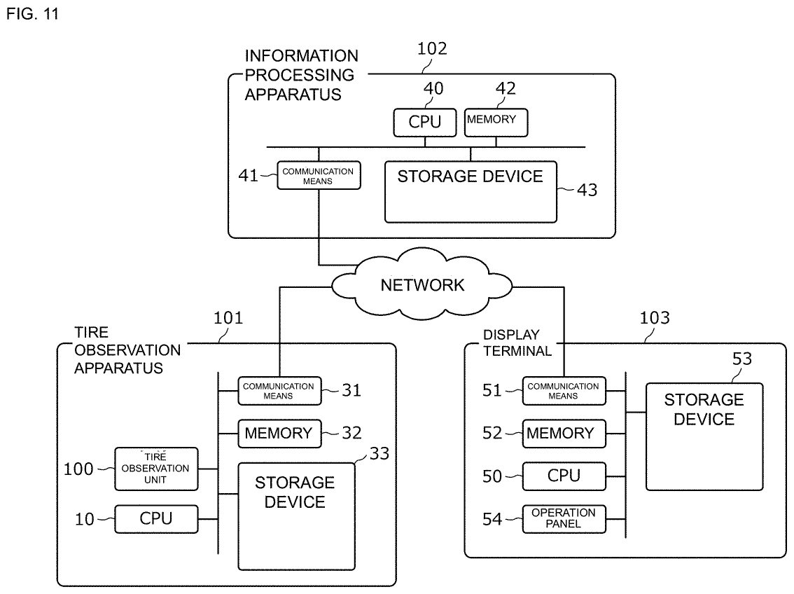

FIG. 11 is a block diagram illustrating a configuration of a tire observation system including the tire observation apparatus 101. In this example, the tire observation apparatus 101, an information processing apparatus 102, and a display terminal 103 are connected to a network such as the Internet or a telephone line network.

The tire observation apparatus 101 includes the tire observation section 100, a CPU 10, a communicator 31, a memory 32, and a storage device 33. The CPU 10 inputs and outputs data and signals to and from the units of the tire observation apparatus 101 and controls the units and the entire apparatus. The communicator 31 communicates with the information processing apparatus 102 and the display terminal 103 through a network. Although illustration is omitted, a tire inspection unit that determines whether or not there is an abnormality in a tire may be provided in the tire observation apparatus 101.

The information processing apparatus 102 includes a CPU 40, a communicator 41, a memory 42, and a storage device 43. There are a plurality of tire observation apparatuses 101. The information processing apparatus 102 stores results of observation by the plurality of tire observation apparatuses 101 and performs statistical processing. In the information processing apparatus 102, the CPU 40 performs various types of processing including history management, replacement prediction, and progress prediction in accordance with a program operation. The history management is management of observation histories of tires of vehicles. The replacement prediction is processing for predicting the time of replacement of tires. The progress prediction is processing for predicting conditions of tires.

The display terminal 103 is a terminal apparatus that displays a result of observation by the tire observation apparatus 101. The display terminal 103 includes a CPU 50, a communicator 51, a memory 52, a storage device 53, and an operation panel 54. The display terminal 103 displays conditions of tires of vehicles in accordance with operation on the operation panel 54.

A tire observation management table that stores information about tires of an observation target vehicle is stored in each of the storage device 33 of the tire observation apparatus 101, the storage device 43 of the information processing apparatus 102, and the storage device 53 of the display terminal 103.

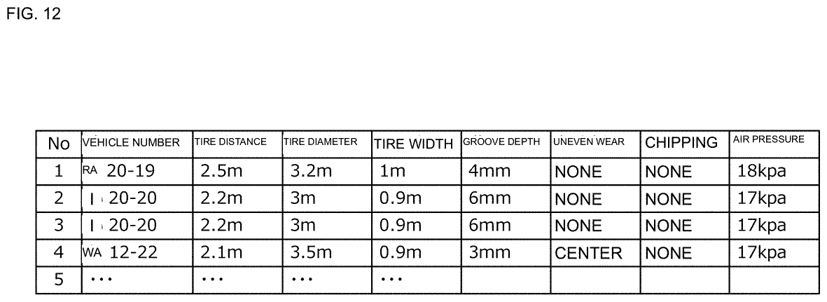

FIG. 12 is a diagram illustrating an example of the tire observation management table. In this example, the tire observation management table includes, for each observation target vehicle, data regarding the number on the number plate of the vehicle, the distance between left and right tires (tread width), the tire diameter, the tire width, the groove depth, the state of uneven wear, the state of chipping, and air pressure.

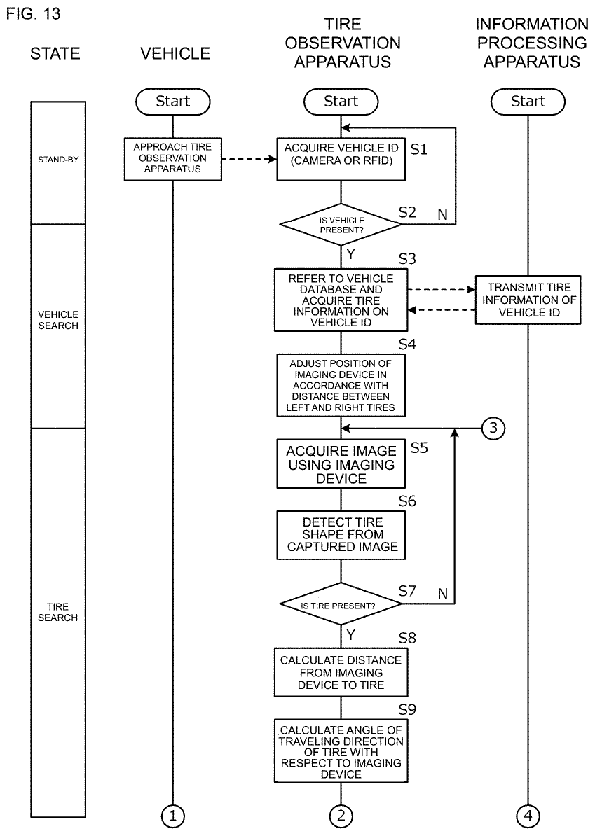

FIG. 13 is a flowchart illustrating an example of the procedure for a process of an observation target vehicle, the tire observation apparatus 101, and the information processing apparatus 102. In a stand-by state, when the vehicle approaches the tire observation apparatus 101, the vehicle identification unit 22 of the tire observation apparatus 101 acquires a vehicle ID (S1). For example, the vehicle ID is acquired based on the number on the number plate of the vehicle acquired by the imaging device or information on an RFID provided at the vehicle. In the case where an observation target vehicle is present, the vehicle information acquisition unit 23 refers to a vehicle database to acquire tire information (diameter, width, distance, etc.) on the vehicle ID (S2→S3). The information processing apparatus 102 transmits the tire information on the vehicle ID to the tire observation apparatus 101.

Then, the position of the imaging device 11 is adjusted in accordance with the distance between the left and right tires (S4). Then, image information by the imaging device 11 is acquired, and the shape detection unit 24 detects the shape of a tire from the image information (S5→S6). In the case where a tire is present, the distance estimation unit 25 calculates the distance between the tire and the imaging device 11 (S7→S8). Then, the angle estimation unit 26 calculates the traveling direction of the tire and the angle (direction) of the tire with respect to the imaging device 11 (S9).

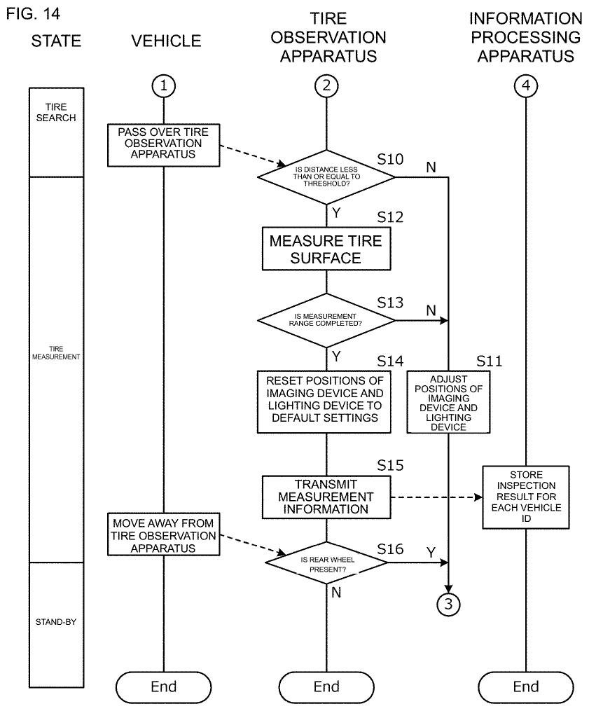

FIG. 14 is a flowchart, continuing from FIG. 13, illustrating the example of the procedure for the process of the observation target vehicle, the tire observation apparatus 101, and the information processing apparatus 102.

Then, the vehicle passes over the tire observation apparatus 101. In the stage in which the distance between the imaging device 11 and the tire is still more than the threshold value, the positions and the angles of the imaging device 11 and the lighting device 12 are appropriately adjusted (S11). The details of step S11 will be described later. Then, the process returns to step S5 illustrated in FIG. 13.

When the distance between the imaging device 11 and the tire drops to less than or equal to the threshold value, the tire surface measurement unit 29 measures the tire surface (S12). The details of step S12 will be described later. When measurement for a measurement range is completed, the positions of the imaging device 11 and the lighting device 12 are reset to default settings (S13→S14). Then, measurement information is transmitted to the information processing apparatus 102 (S15).

Then, if observation of a rear wheel has not yet been performed, the process returns to step S5 illustrated in FIG. 13 (S16→(3)→S5). When observation of a rear wheel is completed, the series of processing operations ends.

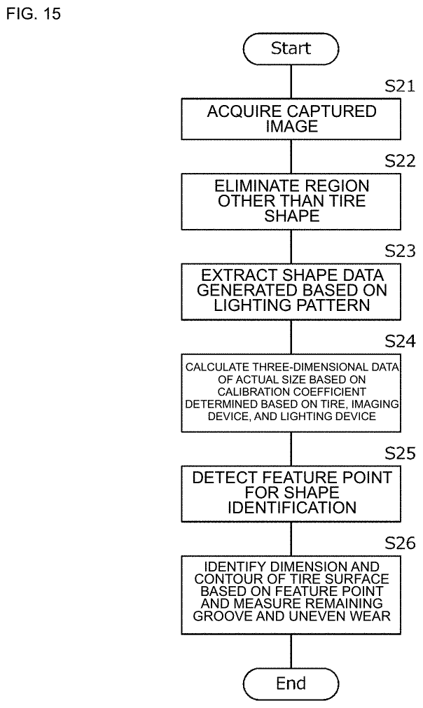

FIG. 15 is a flowchart illustrating the details of the processing of step S12 in FIG. 14. First, information on a captured image is acquired, and a region other than a tire shape is eliminated (S21→S22). Then, data on a shape generated based on a lighting pattern is extracted, and three-dimensional data of actual size is calculated based on a calibration coefficient determined from the positional relationship among the tire, the imaging device, and the lighting device (S23→S24).

Then, feature points for shape recognition are detected based on the three-dimensional data (S25). The dimension and the contour of the tire surface are identified from the feature points, and remaining grooves and uneven wear are measured (S26). Steps S21 to S26 are performed by the tire surface measurement unit.

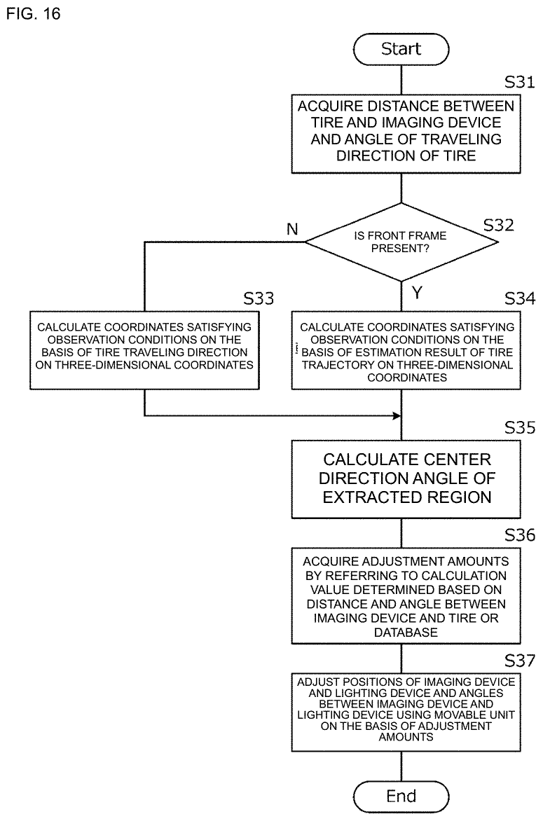

FIG. 16 is a flowchart illustrating the details of the processing of step S11 in FIG. 14. First, the distance between the tire and the imaging device 11 calculated in step S8 and the angle of the traveling direction of the tire calculated in step S9 are acquired (S31). If there is no preceding frame of moving image information, coordinates of the tire at the time when the observation conditions are satisfied are calculated based on the traveling direction of the tire on the three-dimensional coordinates (S32→S33). The traveling direction of the tire is estimated by, for example, image recognition for the tire. Specifically, an image representing the outer shape of the tire, an image representing the outer shape of a wheel, and an image of grooves of the tire are stored for each angle of the tire. The angle of the tire is estimated by matching processing using the stored images, and the traveling direction of the tire is estimated from the angle of the tire.

If there is a preceding frame, the positions of the tire at a plurality of points in time are calculated from images of the tire acquired at the plurality of points in time. The trajectory of the tire on the three-dimensional coordinates is estimated based on the results of calculation of the positions of the tire at the plurality of points in time, and coordinates of the tire at the time when the observation conditions are satisfied are calculated (S34).

Although an aspect in which moving images are used has been described above, moving images are not necessarily used. Still images at a plurality of points in time acquired at predetermined time intervals may be used. Furthermore, the trajectory of a tire may be estimated based on the moving speed of the tire. Estimation accuracy can be increased by using the moving speed of the tire. The moving speed of a tire may be calculated, for example, by calculating the difference between positions of the tire at a plurality of points in time based on images obtained at the plurality of points in time and dividing the difference in position by a time difference between the plurality of points in time.

After that, the angle in the center direction of the extracted region illustrated in FIGS. 4A and 4B is calculated (S35). Then, a calculation value determined based on the distance and the angle between the tire and the imaging device 11 or the database is referred to, and the adjustment amounts of the imaging device 11 and the lighting device 12 are acquired (S36). Then, based on the adjustment amounts, the positions and the angles of the imaging device 11 and the lighting device 12 are adjusted by the movable unit 14 (S37). Steps S33 and S34 are performed by the trajectory estimation unit 27, and step S35 and subsequent steps are performed by the position adjustment unit 28.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A tire observation apparatus comprising:
an imager to acquire image information on a traveling vehicle including a tire;
a trajectory estimator to estimate a trajectory of the tire based on the image information obtained at at least one point in time and tire information including at least one of a width of the tire, a diameter of the tire, and a groove pattern of the tire;
a position adjuster to calculate, based on the trajectory, an adjustment amount that satisfies observation conditions regarding a position and an angle of the imager for observation of a state of the tire; and
a movable assembly to change the position and the angle of the imager based on the adjustment amount.

2. The tire observation apparatus according to claim 1, further comprising:
a tire information acquirer to acquire the tire information; wherein
the tire information acquirer is operable to acquire the tire information based on identification information on the vehicle obtained from the image information or identification information on the vehicle input in advance.

3. The tire observation apparatus according to claim 2, wherein the identification of the vehicle is information obtained from at least one of a number plate of the vehicle and an electronic tag located at the vehicle or the tire.

4. The tire observation apparatus according to claim 1, wherein the trajectory estimator is operable to estimate the trajectory of the tire based on a shape of the tire obtained from the image information.

5. The tire observation apparatus according to claim 1, wherein the trajectory estimator is operable to estimate the trajectory of the tire based on a contour of an outer circumference of the tire and a contour of an inner circumference of the tire that are obtained from the image information as a shape of the tire and a width of the tire or a diameter of the tire as the tire information.

6. The tire observation apparatus according to claim 1, wherein the trajectory estimator is operable to estimate the trajectory of the tire based on a geometric shape of grooves of the tire obtained from the image information as a shape of the tire and a groove pattern of the tire as the tire information.

7. The tire observation apparatus according to claim 1, wherein the trajectory estimator is operable to estimate the trajectory of the tire based on a contour shape of the entire tire obtained from the image information at a plurality of points in time as a shape of the tire and a width of the tire or a diameter of the tire as the tire information.

8. The tire observation apparatus according to claim 1, wherein the trajectory estimator is operable to:
calculate a positional relationship between the tire and the imager based on the image information and the tire information; and
estimate the trajectory of the tire based on the positional relationship.

9. The tire observation apparatus according to claim 8, wherein the positional relationship between the tire and the imager includes a horizontal distance and a horizontal direction angle between the tire and the imager.

10. The tire observation apparatus according to claim 1, wherein the trajectory estimator is operable to:
calculate a moving speed of the tire from the image information obtained at a plurality of points in time; and
estimate the trajectory of the tire based on the moving speed of the tire.

11. The tire observation apparatus according to claim 1, wherein the trajectory estimator is operable to acquire positions of the tire on a horizontal plane in time-series at a plurality of points in time from the image information obtained at the plurality of points in time and estimates the trajectory of the tire.

12. The tire observation apparatus according to claim 1, wherein
the imager is operable to acquire the image information for left and right tires separately; and
the trajectory estimator is operable to estimate the trajectory of the tire based on a distance between the left and right tires.

13. The tire observation apparatus according to claim 1, wherein the position adjuster is operable to calculate the adjustment amount so that, at a time of observation of the state of the tire, an image of the tire is positioned at the center of an image captured by the imager.

14. The tire observation apparatus according to claim 1, further comprising a lighting device to emit light for imaging by the imager.

15. The tire observation apparatus according to claim 1, further comprising a state manager to manage transitions between multiple states of observation.

16. The tire observation apparatus according to claim 15, wherein the multiple states of observation include vehicle search, front-wheel search, front-wheel measurement, rear-wheel search, and rear-wheel measurement.

17. The tire observation apparatus according to claim 1, further comprising a vehicle identifier to identify an observation target vehicle.

18. The tire observation apparatus according to claim 1, further comprising a shape detector to detect a shape of the tire.

19. The tire observation apparatus according to claim 1, further comprising a distance estimator to estimate a distance from the imager to the tire.

20. The tire observation apparatus according to claim 1, further comprising an angle estimator to estimate an angle of a traveling direction of the tire with respect to the imager.
